(19) United States
(12) Patent Application Publication
(10) Pub. No.: US 2013/0081555 A1
(43) Pub. Date: Apr. 4, 2013

(54) TRANSPARENT SUPER HYDROPHOBIC COATING

(71) Applicant: PRESTONE PRODUCTS COMPANY, Lake Forest, IL (US)

(72) Inventor: Bing Li, Danbury, CT (US)

(73) Assignee: PRESTONE PRODUCTS COMPANY, Lake Forest, IL (US)

(21) Appl. No.: 13/628,349

(22) Filed: Sep. 27, 2012

Related U.S. Application Data
(60) Provisional application No. 61/541,694, filed on Sep. 30, 2011.

(51) Int. Cl. C09D 5/16

(52) U.S. Cl. 106/285

(57) ABSTRACT

Disclosed herein is a composition comprising hydrophobically modified aluminum oxide particles; a hydrophobizing agent; a siloxane solvent and a hydrocarbon solvent. The composition can further comprise a propellant. The composition, when applied to an automotive surface and the solvents are allowed to evaporate, yields a transparent coating which is super hydrophobic. Also described herein is a method of making the composition.

### CROSS REFERENCE TO RELATED APPLICATIONS

This application claims the benefit of U.S. Provisional Patent Application Ser. No. 61/541,694 titled “Transparent Super Hydrophobic Coating” and filed Sep. 30, 2011, the contents of which are incorporated herein by reference in their entirety.

### BACKGROUND

Automotive surfaces are readily dirtied by soil insults. Soil insults can be aqueous or non-aqueous, organic or inorganic, solutions, suspensions or dry soils, such as dust. Often multiple insults comprise a mixture of many different types of soil. Automotive surfaces may be treated with wax or other appearance polishes to temporarily protect an automotive surface but these surface treatments do not keep a vehicle clean. Thus, there is a need for a coating which both protects an automotive surface and keeps an automotive surface clean.

The desired coating compositions for automotive surfaces present special and specific issues. It is desirable for the coating composition to be useful for a range of surfaces and substrates. In some instances it is desirable for the coating composition to be useful for one type of surface or substrate, such as a painted surface, and do no harm to a second type of surface or substrate such as rubber or plastic. Additionally it is desirable that the coating composition result in a coating having a transparent glossy finish without haze, streaking or altering the color of the surface or substrate below. Furthermore, a coating durability of greater than or equal to a month is desirable and the coating should wear without discoloration, chipping, hazing, or crazing. Currently, no coating composition is available that adequately meets the majority of these characteristics.

### BRIEF DESCRIPTION

Transparent super hydrophobic coatings may be used to address the aforementioned challenges. Super hydrophobic coatings may have a static water contact angle equal to or greater than 150° and a roll-off angle less than 10°. Disclosed herein is a composition comprising hydrophobically modified aluminum oxide particles; a hydrophobizing agent; a siloxane solvent and a hydrocarbon solvent. The composition can further comprise a propellant. The composition, when applied to an automotive surface and the solvents are allowed to evaporate, yields a transparent coating which is super hydrophobic. Also described herein is a method of making the composition.

The above described and other features are exemplified by the following detailed description.

### DETAILED DESCRIPTION

The composition mentioned above and described in greater detail below forms a transparent, super hydrophobic coating when applied to a surface, particularly an automotive surface. Transparency is important, particularly in automotive applications, since the lack of transparency would alter aesthetic appeal of the vehicle. Transparency is typically measured on chrome-plated panels.

Colorimetric, gloss, and haze measuring instrumentation and techniques can be used to characterize the transparency of the coatings formed by the inventive compositions. In a transparency test, appearance measurements of chrome-plated panels are taken either before or after being coated with the inventive composition under identical conditions. The difference is then calculated to determine changes as a result of the treatment. All measurements are generally replicates of duplicate.

As a colorimeter is employed, Delta E is reported. Delta E is the total color difference between the sample and a reference sample, or alternatively the initial untreated and final post-treated sample after treatment was applied. A small Delta E indicates little or no color variation. Delta E less than or equal to 3.0 indicates that the naked human eye would find it difficult to distinguish between the coated and uncoated surface. As a haze gloss meter is employed, Delta Haze unit is reported. Haze unit measurement obtained is uncompensated values determined after calibration. Delta Haze units correspond to the difference in measured Haze units obtained by subtraction of haze unit values obtained before and after treatment of a chrome-plated panel. Delta Haze units below 250 indicate that the coating is transparent and nearly invisible to the eye.

Hydrophobically modified aluminum oxide particles that may be used include aluminum oxide particles that have been hydrophobized by any means known in the art. In some embodiments of the invention, fumed aluminum oxide particles are utilized. Hydrophobically modified fumed aluminum oxide particles are produced by treating their surface with hydrophobizing agents such as octylsilane. Such products are commercially available from a number of sources, including Evonik Industries AG (under the trade name AEROXIDE® Alu C 805).

Other aluminum oxide materials are also suitable when hydrophobically modified by use of hydrophobizing agents capable of rendering the surfaces of the aluminum oxide particles hydrophobic. The hydrophobizing agents include all those common in the art that are compatible for use with the aluminum oxide materials to render their surfaces hydrophobic. Examples, include, but are not limited to, the organosilanes, alkylsilanes, the fluorinated silanes, and/or the disilazanes. Suitable organosilanes include, but are not limited to alkylchlorosilanes; alkoxysilanes, e.g., methyltrimethoxysilane, methyltriethoxysilane, ethyltrimethoxysilane, ethyltriethoxy-silane, n-propyltrimethoxysilane, n-propyltriethoxysilane, i-propyltrimethoxysilane, i-propyltriethoxysilane, butyltrimethoxysilane, butyltriethoxysilane, hexyltrimethoxy-silane, octyltrimethoxysilane, 3-mercaptopropyl-trimethoxysilane, n-octyltriethoxy-silane, phenyltriethoxysilane, polytriethoxysilane; trialkoxyarylsilanes; isooctyltrimethoxy-silane; N-(3-triethoxysilylpropyl) methoxyethoxyethoxy ethyl carbamate; N-(3-triethoxysilylpropyl) methoxyethoxyethoxyethyl carbamate; polydialkylsiloxanes including, e.g., polydimethylsiloxane; arylsilanes including, e.g., substituted and unsubstituted arylsilanes; alkylsilanes including, e.g., substituted and unsubstituted alkyl silanes including, e.g., methoxy and hydroxy substituted alkyl silanes; and combinations thereof. Some suitable alkylchlorosilanes include, for example, methyltrichlorosilane, dimethyldichlorosilane, trimethylchlorosilane, octylmethyldichlorosilane, octyltrichlorosilane, octadecylmethyldi-chlorosilane and octadecyltrichlorosilane. Other suitable materials include, for example, methylmethoxysilanes such as methyltrimethoxysilane, dimethyldimethoxysilane and trimethylmethoxysilane; methylethoxysilanes such as methyltriethoxysilane, dimethyldiethoxysilane and trimethylethoxysilane; methylacetoxysilanes such as methyltriacetoxysilane, dimethyldiacetoxysilane and trimethylacetoxysilane; vinylsilanes such as vinyltrichlorosilane, vinylmethyldichlorosilane, vinyldimethylchlorosilane, vinyltrimethoxysilane, vinylmethyldimethoxysilane, vinyldimethylmethoxysilane, vinyltriethoxysilane, vinylmethyldiethoxysilane and vinyldimethylethoxysilane.

Fluorinated silanes include, but are not limited to, the fluorinated alkyl-, alkoxy-, aryl- and/or alkylaryl-silanes, and fully perfluorinated alkyl-, alkoxy-, aryl- and/or alkylaryl-silanes. Examples of fluoroalkyl silanes include, but are not limited to those marketed by Evonik Industries AG under the trade name of Dynasylan®. An example of a suitable fluorinated alkoxy-silane is perfluorooctyl trimethoxysilane.

Disilazanes, include for example, but are not limited to hexamethyldisilazane, divinyltetramethyldisilazane and bis(3,3trifluoropropyl)tetramethyldisilazane. Cyclosilazanes are also suitable, and include, for example, octamethylcyclotetrasilazane. It is noted that the aforementioned disilazanes and cyclosilazanes typically have the basic formula (I) and (II)

(R¹R²R³Si)₂NR⁴ (I)

—(R¹R²SiNR⁴)ₘ(cyclo) (II)

wherein R¹, R², and R³ can be the same or different and are independently hydrogen, straight or branched, saturated or unsaturated alkyl chain groups of from 1 to 8 carbon atoms, optionally substituted with fluorine atoms, aromatic groups of from 6 to 12 carbon atoms, optionally substituted with fluorine atoms, R⁴ is hydrogen or methyl group, m is from 3 to 8.

The hydrophobically modified aluminum oxide particles are aggregates of nanoparticles. The aggregates can have a bimodal particle size distribution with modes at 0.2-0.5 micrometers and 4-8 micrometers. The median particle size for the aggregates can be 2 to 7 micrometers. The maximum aggregate particle size can be 15 to 25 micrometers. The minimum aggregate particle size can be 100 to 200 nanometers. In one embodiment, the median aggregate particle size is 3-5 micrometers, the maximum aggregate particle size is 19-21 micrometers and the minimum aggregate particle size is 140-160 nanometers.

The organosilanes, alkylsilanes, fluorinated silanes, and/or the disilazanes described above can also be used as the hydrophobizing agent in forming the composition. The hydrophobizing agent used to form the hydrophobically modified fumed aluminum oxide can be the same as or different from the hydrophobizing agent used in forming the composition. For example, in one embodiment, the hydrophobizing agent used to make the hydrophobically modified fumed aluminum oxide comprises octylsilane and the hydrophobizing agent used in the composition comprises hexamethyldisilazane.

The siloxane solvent can comprise a linear or cyclic polydimethylsiloxane having 2 to 10 dimethylsiloxy units. Exemplary siloxane solvents include decamethylcyclopentasiloxane, octamethylcyclotetrasiloxane, octamethyltrisiloxane, and combinations of two or more of the foregoing siloxanes.

The hydrocarbon solvent can comprise an aliphatic or aromatic hydrocarbon having 2 to 14 carbon atoms as well as mixtures of hydrocarbons having 2 to 14 carbon atoms. The aliphatic hydrocarbon can be linear or cyclic. An exemplary hydrocarbon solvent is mineral spirits.

In some embodiments the weight ratio of the siloxane solvent to the hydrocarbon solvent can be 1:1 to 1:5.

The hydrophobically modified aluminum oxide particles can be present in an amount of 0.10 to 2.0 weight percent based on the combined weight of the hydrophobically modified aluminum oxide particles, hydrophobizing agent, siloxane solvent and hydrocarbon solvent. Within this range the amount of hydrophobically modified aluminum oxide particles can be greater than or equal to 0.2 weight percent. Also within this range the amount of hydrophobically modified aluminum oxide particles can be less than or equal to 0.40 weight percent.

The hydrophobizing agent can be present in an amount of 0.01 to 5.0 weight percent based on the combined weight of the hydrophobically modified aluminum oxide particles, hydrophobizing agent, siloxane solvent and hydrocarbon solvent. Within this range the amount of hydrophobizing agent can be greater than or equal to 0.10 weight percent. Also within this range the amount of hydrophobizing agent can be less than or equal to 0.20 weight percent.

The siloxane solvent can be present in an amount of 10 to 90 weight percent based on the combined weight of the hydrophobically modified aluminum oxide particles, hydrophobizing agent, siloxane solvent and hydrocarbon solvent. Within this range the amount of siloxane solvent can be greater than or equal to 20 weight percent. Also within this range the amount of siloxane solvent can be less than or equal to 50 weight percent.

The hydrocarbon solvent can be present in an amount of 10 to 90 weight percent based on the combined weight of the hydrophobically modified aluminum oxide particles, hydrophobizing agent, siloxane solvent and hydrocarbon solvent. Within this range the amount of hydrocarbon solvent can be greater than or equal to 20 weight percent. Also within this range the amount of siloxane solvent can be less than or equal to 50 weight percent.

The composition may additionally comprise a propellant. Exemplary propellants include a hydrocarbon, of from 1 to 10 carbon atoms, such as n-propane, n-butane, isobutane, n-pentane, isopentane, and mixtures thereof; dimethyl ether and blends thereof as well as individual and mixtures of chloro-, chlorofluoro- and/or fluorohydrocarbons- and/or hydrochlorofluorocarbons (HCFCs). Useful commercially available compositions include A-70 (Aerosol compositions with a vapor pressure of 70 p.s.i.g. available from companies such as Diversified and Aeropress) and Dymel 152a (1,1-difluoroethane from DuPont). Also suitable as propellants are compressed gases such as carbon dioxide, compressed air, nitrogen, and possibly dense or supercritical fluids may also be used, either alone or in combination, and alternatively in combination with other propellant types.

If a propellant is used, it will generally be in an amount of from about 1 weight percent to about 50 weight percent of the total composition. Generally, the amount of a particular propellant employed should provide an internal pressure of from about 20 to about 150 p.s.i.g. at 70° F. in order to provide good atomization and delivery of the inventive treatment compositions.

The composition may further comprise a durability agent. Durability agents may be selected from the group of alkoxysilanes of the general formula (III)

R⁵ₐSi(OR⁶)₄₋ₐ (III)

wherein R⁵ is a straight or branched, saturated or unsaturated alkyl chain group of from 1 to 16 carbon atoms, optionally substituted with fluorine atoms, hydroxyl, amino, mercapto, or epoxy groups, R⁶ is an alkyl chain of 1 to 2 carbon atoms, a is 1 or 2; or selected form the group of alkyl-modified linear or cyclic polydimethylsiloxanes of the general formulas (IV) and (V)

(CH3)3SiO[(CH3)2SiO]n[(CH3)R7SiO]oSi(CH3)3 (IV)

—[(CH3)2SiO]p[((CH3)R7SiO]q-(cyclo) (V)

wherein R⁷ is an alkyl chain group of from 6 to 24 carbon atoms, n is from 1 to 100, o from 1 to 40, p from 0 to 7, q from 1 to 7, provided that the sum (p+q) is at least 3. Additional durability agents suitable for use herein include those previously disclosed in U.S. Patent Publication No. 2004/0213904 A1. The durability agent may be used in an amount of 0.1 and 10 weight percent based on the combined weight of the hydrophobically modified aluminum oxide particles, hydrophobizing agent, siloxane solvent and hydrocarbon solvent.

The composition may be made by making a first mixture comprising the siloxane solvent, the hydrophobizing agent and hydrophobically modified aluminum oxide particles wherein the hydrophobically modified aluminum oxide particles are present in an amount of 15 to 25 weight percent, based on the total weight of the first mixture. The first mixture is then subjected to high shear mixing and then diluted by the siloxane solvent to make a second mixture having 5 to 14 weight percent hydrophobically modified aluminum oxide particles, based on the total weight of the second mixture. The second mixture is also subjected to high shear mixing and then diluted by the siloxane solvent and the hydrocarbon solvent to make a third mixture having the amount of hydrophobically modified aluminum oxide particles equivalent to the amount present in the final composition. The third mixture is subjected to high shear mixing and any additional components are added to form the composition.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to d one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A composition comprising hydrophobically modified aluminum oxide particles; a hydrophobizing agent; a siloxane solvent and a hydrocarbon solvent.

2. The composition of claim 1, wherein the hydrophobically modified aluminum oxide particles are present in an amount of 0.10 to 2.0 weight percent based on the combined weight of the hydrophobically modified aluminum oxide particles, hydrophobizing agent, siloxane solvent and hydrocarbon solvent.

3. The composition of claim 1, wherein the hydrophobizing agent is present in an amount of 0.01 to 5.0 weight percent based on the combined weight of the hydrophobically modified aluminum oxide particles, hydrophobizing agent, siloxane solvent and hydrocarbon solvent.

4. The composition of claim 1, wherein the siloxane solvent is present in an amount of 10 to 90 weight percent based on the combined weight of the hydrophobically modified aluminum oxide particles, hydrophobizing agent, siloxane solvent and hydrocarbon solvent.

5. The composition of claim 1, wherein the hydrocarbon solvent is present in an amount of 10 to 90 weight percent based on the combined weight of the hydrophobically modified aluminum oxide particles, hydrophobizing agent, siloxane solvent and hydrocarbon solvent.

6. The composition of claim 1, further comprising a propellant.

7. The composition of claim 6, wherein the propellant is present an amount of from about 1 weight percent to about 50 weight percent of the total composition.

8. The composition of claim 1, further comprising a durability agent.

9. The composition of claim 8, wherein the durability agent is present in an amount of 0.1 and 10 weight percent based on the combined weight of the hydrophobically modified aluminum oxide particles, hydrophobizing agent, siloxane solvent and hydrocarbon solvent.

10. The composition of claim 1, wherein the hydrophobically modified aluminum oxide particles are aggregates having a median particle size of 2 to 7 micrometers.

11. The composition of claim 1, wherein the hydrophobically modified aluminum oxide particles are aggregates having a bimodal particle size distribution.

12. The composition of claim 1, wherein the hydrophobically modified aluminum oxide particles are aggregates having a maximum aggregate particle size of 15 to 25 micrometers.

13. The composition of claim 1, wherein the hydrophobically modified aluminum oxide particles are aggregates having a minimum aggregate particle size of 100 to 200 nanometers.

14. The composition of claim 1, wherein the siloxane solvent comprises decamethylcyclopentasiloxane, octamethylcyclotetrasiloxane, octamethyltrisiloxane, or a combination of two or more of the foregoing siloxanes.

15. The composition of claim 1, wherein the volume ratio of the siloxane solvent to the hydrocarbon solvent is 1:1 to 1:5.
